(19) United States
(12) Patent Application Publication
(10) Pub. No.: US 2026/0089431 A1
(43) Pub. Date: Mar. 26, 2026

(54) CONNECTION STRUCTURE, HEADPHONE, AND HEADPHONE SYSTEM

(71) Applicant: SUUNTO SPORTS TECHNOLOGY (DONGGUAN) CO., LTD., Dongguan (CN)

(72) Inventors: Junlin CHEN, Dongguan (CN); Zhonglin ZHANG, Dongguan (CN); Biao HU, Dongguan (CN)

(21) Appl. No.: 19/403,281

(22) Filed: Nov. 28, 2025

Related U.S. Application Data
(63) Continuation of application No. PCT/CN2024/116063, filed on Aug. 30, 2024.

(51) Int. Cl. H04R 1/10

(52) U.S. Cl. CPC H04R 1/1066; H04R 1/1025; H04R 2460/13

(57) ABSTRACT

Provided is a connection structure including a functional box, a connection component, and an anti-detachment member. A box body of the functional box is provided with a connection portion. An insertion hole of the connection portion is configured to allow the connection component to be inserted into the insertion hole. The connection component is provided with a protuberance abutting against a sidewall of the functional box. The anti-detachment member is disposed in a mounting cavity of the functional box, and is configured to connect the functional box with the connection component.

### CROSS-REFERENCE TO RELATED APPLICATION

This application is a continuation of International Application No. PCT/CN2024/116063, filed on Aug. 30, 2024, the entire contents of which are incorporated herein by reference.

### FIELD

The present disclosure relates to the field of headphone technologies, and more particularly, to a connection structure, a headphone, and a headphone system.

### BACKGROUND

A functional box assembly of a headphone typically includes a control box assembly and a battery box assembly. The functional box assembly has an end connected to an ear hook and another end connected to a rear hook. Currently, an anti-detachment member for fixing two components (the functional box assembly and the ear hook, or the functional box assembly and the rear hook) is usually disposed outside the functional box. The anti-detachment member extends from an outside of the functional box to an inside of the functional box to fix the functional box assembly to the rear hook and/or fix the functional box assembly to the ear hook.

### SUMMARY

Embodiments of the present disclosure provide a connection structure, a headphone, and a headphone system.

A connection structure according to an embodiment of the present disclosure includes a functional box, a connection component, and an anti-detachment member. The functional box includes a box body and a cover body mounted at the box body. The cover body is engaged with the box body to define a mounting cavity. The box body is provided with a connection portion on at least one end of the box body. The connection portion has an insertion hole extending through the connection portion. The insertion hole is configured to communicate the mounting cavity with an external environment. The connection component is connected to the functional box. The insertion hole is configured to allow the connection component to be inserted into the insertion hole. The connection component is provided with a protuberance abutting against a sidewall of the functional box. The anti-detachment member is located in the mounting cavity. The anti-detachment member is configured to fixedly connect the functional box with the connection component.

In some embodiments, the connection portion further has a connection hole located in the mounting cavity and in communication with the insertion hole. The connection component has a mating hole corresponding to the connection hole. The anti-detachment member passes through the connection hole and the mating hole to connect the functional box with the connection component.

In some embodiments, an extension direction of the connection hole is different from an extension direction of the insertion hole.

In some embodiments, the extension direction of the connection hole is perpendicular to the extension direction of the insertion hole.

In some embodiments, the insertion hole extends through two opposite sidewalls of the connection portion. The connection hole extends through a top wall of the connection portion, and two ends of the top wall are connected to the two opposite sidewalls of the connection portion.

In some embodiments, at least part of the connection component extends into the mounting cavity. The anti-detachment member is disposed at an end of the connection component disposed in the mounting cavity, and the end of the connection component is disposed in the mounting cavity. The anti-detachment member is engaged with a sidewall of the connection portion to connect the functional box with the connection component.

In some embodiments, the anti-detachment member is a snap hook snapped with the sidewall of the connection portion.

In some embodiments, the connection component includes an expansion bolt inserted into the insertion hole and engaged with a sidewall of the insertion hole. The anti-detachment member is disposed at an end of the expansion bolt, and the end of the expansion bolt is disposed in the mounting cavity. The anti-detachment member is a snap hook snapped with the sidewall of the connection portion.

In some embodiments, the cover body and the box body are connected to each other through adhesive bonding.

In some embodiments, one of the box body or the cover body is provided with at least two first protuberances spaced apart from each other, and each of the at least two first protuberances is formed into an annular shape. A first adhesive groove is formed between two adjacent first protuberances of the at least two first protuberances. The other one of the box body or the cover body is provided with a second protuberance engaged into the first adhesive groove in male-female fit.

In some embodiments, one of the box body or the cover body is provided with at least two third protuberances spaced apart from each other, and each of the at least two third protuberances is formed into an annular shape. A second adhesive groove is formed between two adjacent third protuberances of the at least two third protuberances. The other one of the box body or the cover body is provided with at least two fourth protuberances spaced apart from each other, and each of the at least two fourth protuberances being formed into an annular shape. A third adhesive groove being formed between two adjacent fourth protuberances of the at least two fourth protuberances. One of the at least two third protuberances is capable of being engaged into the third adhesive groove in male-female fit, and one of the at least two fourth protuberances is capable of being engaged into the second adhesive groove in male-female fit.

In a thickness direction of the functional box, in some embodiments, a height of one of the at least two third protuberances proximal to the mounting cavity is lower than a height of one of the at least two third protuberances distal from the mounting cavity.

In the thickness direction of the functional box, in some embodiments, a height of one of the at least two fourth protuberances proximal to the mounting cavity is lower than a height of one of the at least two fourth protuberances distal from the mounting cavity.

In a thickness direction of the functional box, in some embodiments, a height of one of the at least two third protuberances proximal to the mounting cavity is lower than a height of one of the at least two third protuberances distal from the mounting cavity, and a height of one of the at least two fourth protuberances proximal to the mounting cavity is lower than a height of one of the at least two fourth protuberances distal from the mounting cavity.

In some embodiments, the functional box further includes a battery box for receiving a battery and/or a control box with a control function.

In some embodiments, the connection component includes an ear hook of a headphone and/or a rear hook of a headphone.

In some embodiments, the connection component includes a sleeve and a mounting portion. The sleeve includes a sleeve body and a protrusion disposed at an end of the sleeve body. An outer side of the protrusion is formed as a sealing member of an annular shape. The protrusion extends into the insertion hole, and the sealing member abuts against an inner wall of the insertion hole. The mounting portion passes through the insertion hole. An end of the mounting portion disposed in the mounting cavity is connected to the functional box by the anti-detachment member, and an end of the mounting portion disposed outside the mounting cavity extends into the protrusion to be connected to the sleeve body. The protrusion is sleeved on an outer sidewall of the mounting portion.

In some embodiments, a plurality of sealing members are provided, and the plurality of sealing members are arranged sequentially at intervals in an extension direction of the protrusion.

In some embodiments, the sealing member has a closed annular structure.

In some embodiments, the sealing member has an intermittent annular structure.

A headphone according to an embodiment of the present disclosure includes the connection structure according to any of the above embodiments.

In some embodiments, the headphone includes a bone conduction headphone or an air conduction headphone.

A headphone system according to an embodiment of the present disclosure includes the headphone according to any of the above embodiments and a charging box configured to charge the headphone.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic perspective view of a headphone according to some embodiments of the present disclosure.

FIG. 2 is a schematic perspective view illustrating a part of a connection structure in the headphone of FIG. 1.

FIG. 3 is a schematic exploded perspective view of the connection structure of FIG. 2.

FIG. 4 is a schematic cross-sectional view of the connection structure of FIG. 2 taken along line IV-IV.

FIG. 5 is a schematic cross-sectional view of the connection structure of FIG. 2 taken along line V-V.

FIG. 6 is a schematic perspective view of a headphone system according to some embodiments of the present disclosure.

### DESCRIPTION OF REFERENCE NUMERALS OF MAIN COMPONENTS

1000: headphone system; 100: headphone; 300: charging box; 10: connection structure; 11: functional box; 111: box body; 1111: connection portion; 1113: insertion hole; 1115: connection hole; 1117: first protuberance; 1119: first adhesive groove; 113: cover body; 1131: second protuberance; 1133: third adhesive groove; 115: mounting cavity; 117: battery box; 119: control box; 13: connection component; 131: mating hole; 132: protuberance; 133: sleeve; 1331: sleeve body; 1333: protrusion; 1335: sealing member; 135: mounting portion; 137: ear hook; 139: rear hook; 15: anti-detachment member; 30: transducer assembly.

### DETAILED DESCRIPTION

In order to make the above objectives, features, and advantages of the present disclosure more apparent, specific embodiments of the present disclosure will be described in detail below with reference to the accompanying drawings. In the following description, many specific details are provided to facilitate full understanding of the present disclosure. However, the present disclosure can be implemented in other ways different from those described herein. Similar improvements can be made by those skilled in the art without contradicting the intent of the present disclosure. Therefore, the present disclosure is not limited by specific embodiments disclosed below.

In the description of the present disclosure, it should be understood that, the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features or more of the features. In the description of the present disclosure, “plurality” means at least two, unless otherwise specifically defined.

In the present disclosure, unless otherwise clearly specified and limited, terms such as “install”, “connect”, “connect to”, “fix” and the like should be understood in a broad sense. For example, it may be a fixed connection or a detachable connection or connection as one piece; mechanical connection or electrical connection; direct connection or indirect connection through an intermediate; internal communication of two components or the interaction relationship between two components, unless otherwise clearly limited. For those of ordinary skill in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

It should be noted that, when an element is described as being “fixed to” or “arranged on” another element, it may be directly on the other element or an intermediate element may exist. When an element is interpreted as being “connected” to another element, it may be directly connected to the other element or an intermediate element may exist simultaneously. As used herein, the terms “vertical”, “horizontal”, “over”, “below”, “left”, and “right” and similar expressions are used for illustrative purposes only and are not meant to be the only means of implementation.

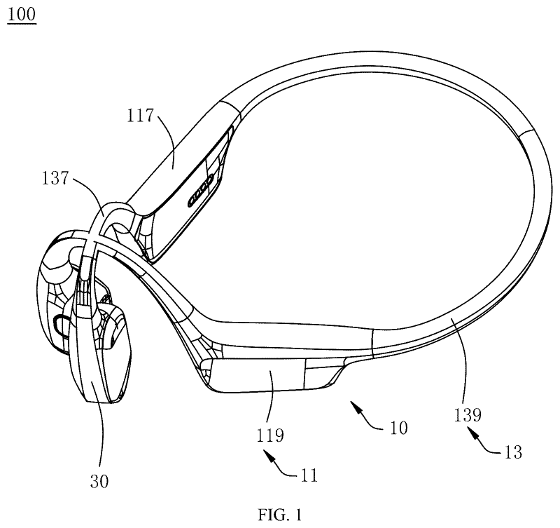

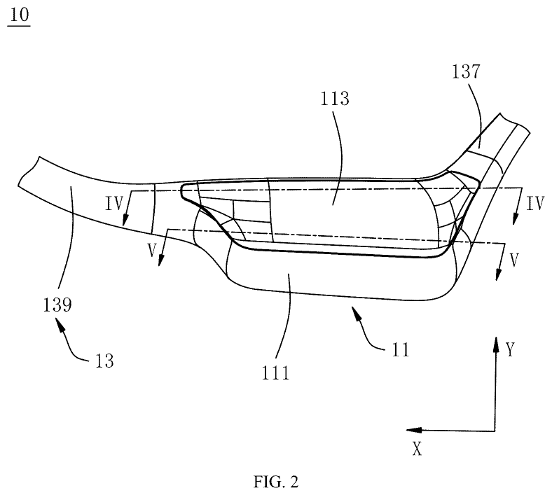

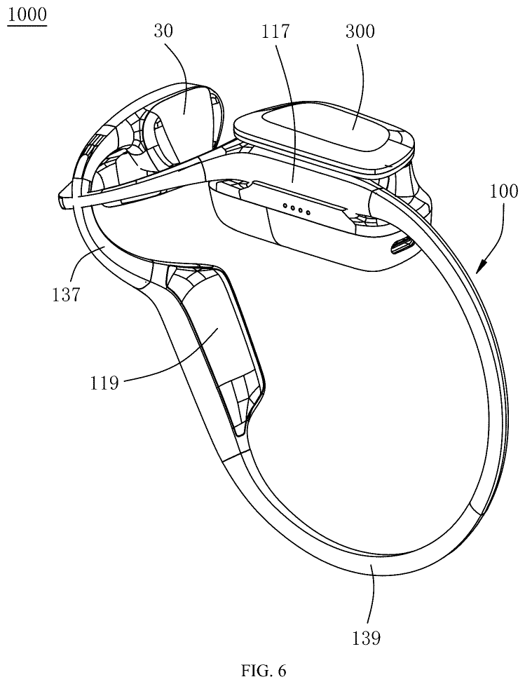

A functional box assembly of a headphone typically includes a control box assembly and a battery box assembly. The functional box assembly has an end connected to an ear hook and another end connected to a rear hook. Currently, an anti-detachment member configured to fix two components (the functional box assembly and the ear hook, or the functional box assembly and the rear hook) is usually disposed outside the functional box. The anti-detachment member extends from an outside of the functional box to an inside of the functional box to fix the functional box assembly to the rear hook and/or fix the functional box assembly to the ear hook. In this case, a predetermined gap exists between the anti-detachment member and the functional box, and thus an external liquid is likely to enter the functional box through the gap, which affects normal operation of a mainboard compartment inside the functional box. To solve this problem, the embodiments of the present disclosure provide a connection structure 10 (illustrated in FIG. 2), a headphone 100 (illustrated in FIG. 1), and a headphone system 1000 (illustrated in FIG. 6).

As illustrated in FIG. 1, the headphone 100 according to an embodiment of the present disclosure includes the connection structure 10. In some embodiments, the headphone 100 includes a bone conduction headphone 100 or an air conduction headphone 100.

The bone conduction headphone 100 uses bones of a human body as a medium to convert sound into mechanical vibrations. The mechanical vibrations transmit sound waves through the bones of the human body, in such a manner that a user can hear the sound. Since the sound from the bone conduction headphone 100 acts on the bones, long-term use of the bone conduction headphone 100 does not cause a significant impact on the eardrum of the user and therefore effectively protects hearing of the user. Sound is transmitted by the air conduction headphone 100 through air vibrations, offering satisfactory sound quality and sound penetration. As an example, the present disclosure describes the headphone 100 as the bone conduction headphone 100.

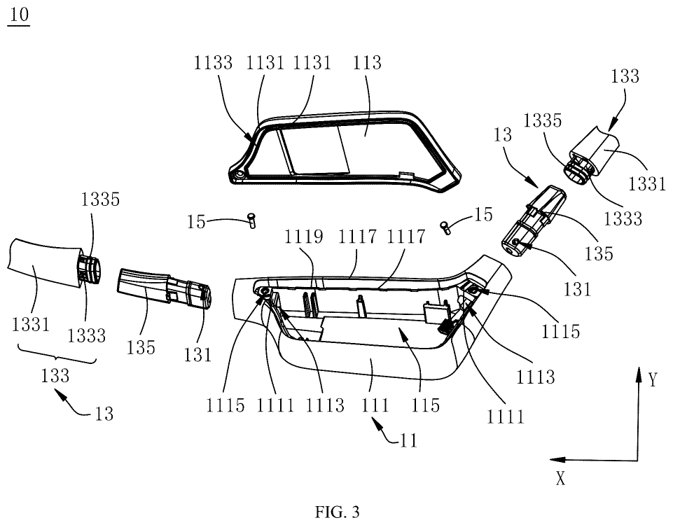

As illustrated in FIG. 2 and FIG. 3, the connection structure 10 according to an embodiment of the present disclosure includes a functional box 11, a connection component 13, and an anti-detachment member 15. The functional box 11 includes a box body 111 and a cover body 113 mounted at the box body 111. The cover body 113 is engaged with the box body 111 to define a mounting cavity 115. The box body 111 is provided with a connection portion 1111 on at least one end of the box body 111. The connection portion 1111 has an insertion hole 1113 extending through the connection portion 1111. The insertion hole 1113 is configured to communicate the mounting cavity 115 with an external environment. The connection component 13 is connected to the functional box 11. The insertion hole 1113 is configured to allow the connection component 13 to be inserted into the insertion hole 1113. The connection component 13 is provided with a protuberance 132 abutting against a sidewall of the functional box 11. The anti-detachment member 15 is located in the mounting cavity 115. The anti-detachment member 15 is configured to fixedly connect the functional box 11 with the connection component 13.

Specifically, as illustrated in FIG. 1, in some embodiments, the functional box 11 includes a battery box 117 for receiving a battery and/or a control box 119 with a control function. In some embodiments, the functional box 11 includes the control box 119. The control box 119 can be configured to control power-on, power-off, and a volume adjustment of the headphone 100. In some embodiments, the functional box 11 includes the battery box 117. The battery box 117 is configured to contain the battery. The battery is configured to supply power to the headphone 100, in such a manner that the headphone 100 can operate normally. The functional box 11 of the present disclosure may include the battery box 117 and the control box 119.

As illustrated in FIG. 3, the mounting cavity 115 is configured to mount the battery, a circuit board, and other components of the headphone 100 in the mounting cavity 115. The box body 111 is detachably connected to the cover body 113. In a case where the cover body 113 is detached from the box body 111, mounting of the battery, the circuit board, and other components of the headphone 100 in the mounting cavity 115 can be facilitated, and maintenance and replacement of the battery, the circuit board, and the other components of the headphone 100 can also be facilitated. In a case where the cover body 113 is mounted on the box body 111, the box body 111 and the cover body 113 can protect the components inside the mounting cavity 115 together, which can effectively avoid a risk that dust, moisture, and the like from the external environment enter the mounting cavity 115 and damage the components inside the mounting cavity 115.

In some embodiments, the cover body 113 and the box body 111 are connected to each other through adhesive bonding. Preferably, a waterproof adhesive may be used for an adhesive connection between the cover body 113 and the box body 111. In this case, the box body 111 is stably connected to the cover body 113 and therefore less likely to detach relative to the box body 111. In addition, satisfactory waterproof performance is realized between the box body 111 and the cover body 113, in such a manner that the external liquid is unlikely to enter the mounting cavity 115 through a gap between the box body 111 and the cover body 113. In a case where the headphone 100 is a swimming headphone 100, when the headphone 100 works underwater, external water is also unlikely to enter the mounting cavity 115 through the gap between the box body 111 and the cover body 113, which can effectively avoid a problem that the external liquid affects normal operation of the components inside the mounting cavity 115. The waterproof adhesive may be, but is not limited to, a polyurethane waterproof adhesive, a nano-silicon waterproof adhesive, an acrylate waterproof adhesive, an ethylene-vinyl acetate copolymer waterproof adhesive, etc.

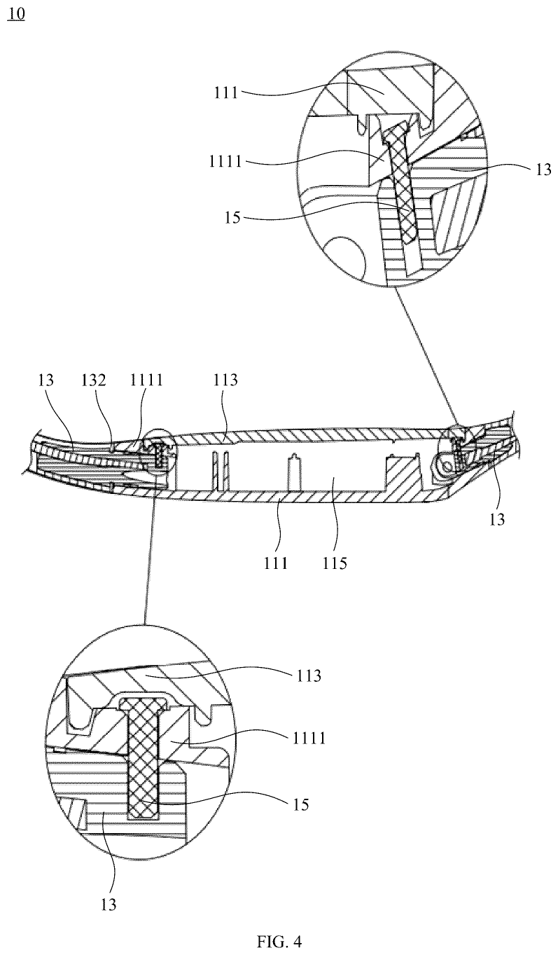

As illustrated in FIG. 3 and FIG. 4, the connection component 13 extends into the insertion hole 1113 to be connected to the functional box 11. The protuberance 132 is disposed on a peripheral wall of the connection component 13. In a case where at least part of the connection component 13 extends into the insertion hole 1113 and is properly mounted to the functional box 11, the protuberance 132 abuts against the sidewall of the functional box 11. The protuberance 132 serves to position mounting of the connection component 13, effectively avoiding problems such as incomplete mounting or over-mounting of the connection component 13. Moreover, in the case where the protuberance 132 tightly abuts against the sidewall of the functional box 11, the external liquid can be prevented from entering the insertion hole 1113 through a gap between the protuberance 132 and the sidewall of the functional box 11.

In some embodiments, the connection component 13 includes an ear hook 137 of the headphone 100 and/or a rear hook 139 of the headphone 100. When the user wears the headphone 100, the rear hook 139 of the headphone 100 is worn on the head, and the ear hook 137 of the headphone 100 is worn behind the ear, enhancing wearing stability of the headphone 100. Thus, even when the user is outdoors or exercising, the headphone 100 is unlikely to fall off. The rear hook 139 is configured to connect the battery box 117 and the control box 119. The headphone 100 further includes a transducer assembly 30. The ear hook 137 is configured to connect the battery box 117 and the transducer assembly 30, and to connect the control box 119 and the transducer assembly 30. The transducer assembly 30 is configured to be attached to the skin of the human body. During use of the headphone 100, the transducer assembly 30 can transmit sound to the user through mechanical vibrations.

In a case where the connection component 13 is the ear hook 137 of the headphone 100 or the rear hook 139 of the headphone 100, the box body 111 is provided with the connection portion 1111 at an end of the box body 111 in a length direction X of the functional box 11. The connection portion 1111 is configured to be connected to the connection component 13, to stably connect the functional box 11 with the connection component 13. In a case where the connection component 13 includes the ear hook 137 of the headphone 100 and the rear hook 139 of the headphone 100, in the length direction X of the functional box 11, the ear hook 137 and the rear hook 139 are connected to two opposite ends of the functional box 11, respectively. In this case, the box body 111 is provided with the connection portion 1111 at each of two opposite ends of the box body 111 in the length direction X of the functional box 11.

As illustrated in FIG. 3 and FIG. 4, the anti-detachment member 15 is located in the mounting cavity 115 and connected to the connection portion 1111. The anti-detachment member is configured to stably connect the functional box 11 with the connection component 13, which can effectively avoid a problem that the connection component 13 detaches relative to the functional box 11. Currently, in the connection structure 10, the anti-detachment member 15 usually extends into the mounting cavity 115 from an outside of the functional box 11 to connect the functional box 11 with the connection component 13. To enhance a waterproof function of the connection structure 10, the functional box 11 is provided with a rubber coating at an outer surface of the functional box 11. However, the rubber coating increases costs of the connection structure 10 and affects an overall appearance of the connection structure 10. In the present disclosure, since the anti-detachment member 15 is disposed in the mounting cavity 115, no holes need to be drilled on a surface of the functional box 11 for mounting the anti-detachment member 15, which makes the external liquid unlikely to enter the mounting cavity 115, effectively avoiding the problem that the external liquid affects the normal operation of the components inside the mounting cavity 115. Further, the functional box 11 of the present disclosure does not require the rubber coating to be formed on the surface thereof, which can save material costs of the connection structure 10, simplify mounting steps of the connection structure 10, and improve aesthetics of the functional box 11.

In the connection structure 10 according to the embodiments of the present disclosure, the connection component 13 extends into the insertion hole 1113 to be connected to the functional box 11. The anti-detachment member 15 is located in the mounting cavity 115, and is configured to further stably connect the functional box 11 with the connection component 13, effectively preventing the connection component 13 from detaching from the functional box 11. Compared with a conventional connection structure 10, the connection structure 10 of the present disclosure realizes that the anti-detachment member 15 enables the functional box 11 to be stably connected to the connection component 13 without needing to penetrate the functional box 11. As a result, the external liquid is unlikely to enter the mounting cavity 115 through a gap between the anti-detachment member 15 and the functional box 11, which enables satisfactory waterproof performance of the connection structure 10, effectively avoiding a problem that the external liquid enters the mounting cavity 115 and affects normal operation of a mainboard compartment inside the functional box 11.

The connection structure 10 is further described below in conjunction with the accompanying drawings.

As illustrated in FIG. 3 and FIG. 4, in some embodiments, the connection portion 1111 further has a connection hole 1115 located in the mounting cavity 115 and in communication with the insertion hole 1113, and the connection component 13 has a mating hole 131 corresponding to the connection hole 1115. The anti-detachment member 15 passes through the connection hole 1115 and the mating hole 131 to connect the functional box 11 with the connection component 13.

The connection hole 1115 is formed on a sidewall of the connection portion 1111. In this embodiment, the anti-detachment member 15 may be a screw or a bolt. In this case, during mounting of the connection structure 10, the cover body 113 may be separated from the box body 111. When the connection component 13 enters the connection portion 1111 through the insertion hole 1113 and the connection hole 1115 corresponds to the mating hole 131, the anti-detachment member 15 may sequentially extend into the connection hole 1115 and the mating hole 131 to stably connect the functional box 11 with the connection component 13. The anti-detachment member 15 can effectively prevent the connection component 13 from moving away from the functional box 11. After the anti-detachment member 15 extends into the connection hole 1115 and the mating hole 131, the cover body 113 may be adhesively bonded to the box body 111 by the waterproof adhesive. Thus, the connection structure 10 has satisfactory waterproof performance, making the external liquid unlikely to enter the mounting cavity 115.

When the anti-detachment member passes through the connection hole 1115 and the mating hole 131 to connect the functional box 11 with the connection component 13, a connection method between the functional box 11 and the connection component 13 is simple. In addition, only hole drilling is required on the functional box 11 and the connection component 13, and thus the functional box 11 and the connection component 13 have simple structures and are easy to manufacture. Also, the functional box 11 is stably connected to the connection component 13.

As illustrated in FIG. 3 and FIG. 4, in some embodiments, an extension direction of the connection hole 1115 is different from an extension direction of the insertion hole 1113. In this case, the extension direction of the connection hole 1115 intersects with the extension direction of the insertion hole 1113. As an example, an angle between the extension direction of the connection hole 1115 and the extension direction of the insertion hole 1113 may be 30°, 50°, 65°, 90°, etc.

An extension direction of the mating hole 131 is the same as the extension direction of the connection hole 1115, helping the anti-detachment member 15 pass through the connection hole 1115 and the mating hole 131. The extension direction of the insertion hole 1113 is a direction in which the connection component 13 extends into the connection portion 1111. The extension direction of the connection hole 1115 and the extension direction of the mating hole 131 are the direction in which the anti-detachment member 15 is inserted into the connection portion 1111 and the connection component 13. When the direction in which the connection component 13 extends into the connection portion 1111 is different from the direction in which the anti-detachment member 15 is inserted into the connection portion 1111, the anti-detachment member 15 can lock the functional box 11 to the connection component 13, effectively preventing the connection component 13 from moving away from the connection portion 1111. When the user uses the headphone 100, the ear hook 137 and/or the rear hook 139 are less likely to detach relative to the functional box 11.

As illustrated in FIG. 3 and FIG. 4, preferably, in some embodiments, the extension direction of the connection hole 1115 is perpendicular to the extension direction of the insertion hole 1113. That is, the angle between the extension direction of the connection hole 1115 and the extension direction of the insertion hole 1113 is 90°. In this case, the anti-detachment member 15 can more stably connect the functional box 11 with the connection component 13, further effectively preventing the connection component 13 from moving away from the connection portion 1111. In addition, manufacturing of the connection hole 1115 and the insertion hole 1113 is also simple.

When the extension direction of the connection hole 1115 is perpendicular to the extension direction of the insertion hole 1113, in some embodiments, the insertion hole 1113 extends through two opposite sidewalls of the connection portion 1111, and the connection hole 1115 extends through a top wall of the connection portion 1111. Two ends of the top wall are connected to the two opposite sidewalls of the connection portion 1111. The connection portion 1111 includes two opposite sidewalls in the length direction X of the functional box 11 and two opposite top walls in a thickness direction Y of the functional box 11. The connection component 13 extends into the insertion hole 1113 in the length direction X of the functional box 11. The anti-detachment member 15 is configured to pass through the connection hole 1115 and the mating hole 131 in the thickness direction Y of the functional box 11, to fixedly connect the functional box 11 with the connection component 13.

As illustrated in FIG. 3 and FIG. 4, in other embodiments, at least part of the connection component 13 extends into the mounting cavity 115, and the anti-detachment member 15 is disposed at an end of the connection component 13, and the end of the connection component 13 is disposed in the mounting cavity 115. The anti-detachment member 15 is engaged with a sidewall of the connection portion 1111 to connect the functional box 11 with the connection component 13. Specifically, in some embodiments, the anti-detachment member 15 may be a snap hook snapped with the sidewall of the connection portion 1111.

The anti-detachment member 15 is connected to an end of the connection component 13. In this case, the anti-detachment member 15 and the connection component 13 may have an integral structure or separate structures. In a case where the anti-detachment member 15 and the connection component 13 have the integral structure, the anti-detachment member 15 and the connection component 13 may be integrally formed, which realizes simple manufacturing steps of the connection structure 10 and a stable connection between the anti-detachment member 15 and the connection component 13. In a case where the anti-detachment member 15 and the connection component 13 have separate structures, the anti-detachment member 15 and the connection component 13 may be detachably or non-detachably connected. Detachable mounting methods include, but are not limited to, threaded connection, screw connection, snap-fit connection, etc. Non-detachable mounting methods include, but are not limited to, welding, adhesive connection, interference fit, etc.

In a case where the connection component 13 extends into the insertion hole 1113, the connection component 13 may drive the anti-detachment member 15 to extend into the insertion hole 1113 together. In a case where the connection component 13 is inserted in place, the anti-detachment member 15 may extend into the mounting cavity 115. In a case where the anti-detachment member 15 is the snap hook, the snap hook may abut against the sidewall of the connection portion 1111. In this case, the engagement between the anti-detachment member 15 and the sidewall of the connection portion 1111 can effectively restrict a movement of the connection component 13 away from the functional box 11.

In a case where the anti-detachment member 15 is the snap hook connected to the connection component 13, the snap hook may extend together with the connection component 13 towards the insertion hole 1113. When the connection component 13 is mounted in place and the snap hook is also mounted in place (the snap hook is engaged with the sidewall of the connection portion 1111), there is no need for an additional step to mount the anti-detachment member 15. Thus, mounting of the anti-detachment member 15 is simple, and mounting steps of the connection structure 10 are also simple.

As illustrated in FIG. 3 and FIG. 4, in some embodiments, the connection component 13 includes an expansion bolt inserted into the insertion hole 1113 and engaged with a sidewall of the insertion hole 1113. The anti-detachment member 15 is disposed at an end of the expansion bolt, and the end of the expansion bolt is disposed in the mounting cavity 115. The anti-detachment member 15 is a snap hook snapped with the sidewall of the connection portion 1111.

In a case where the connection component 13 is the expansion bolt, after the connection component 13 extends into the insertion hole 1113, the snap hook may extend into the mounting cavity 115 to be engaged with the sidewall of the connection portion 1111. In this case, the connection component 13 may tightly abut against the sidewall of the insertion hole 1113 (i.e., the connection portion 1111), resulting in a large friction force between the connection component 13 and the sidewall of the insertion hole 1113. In this way, the connection component 13 is more tightly connected to the functional box 11, which makes the connection component 13 unlikely to move away from the functional box 11. Thus, the connection component 13 is unlikely to detach relative to the functional box 11.

In other embodiments, the anti-detachment member 15 may include a screw that passes through the connection hole 1115 and the mating hole 131 and a snap hook connected to an end of the connection component 13. In this case, when the anti-detachment member 15 connects the functional box 11 with the connection component 13, the functional box 11 is more stably connected to the connection component 13, further avoiding a problem that the connection component 13 detaches relative to the functional box 11.

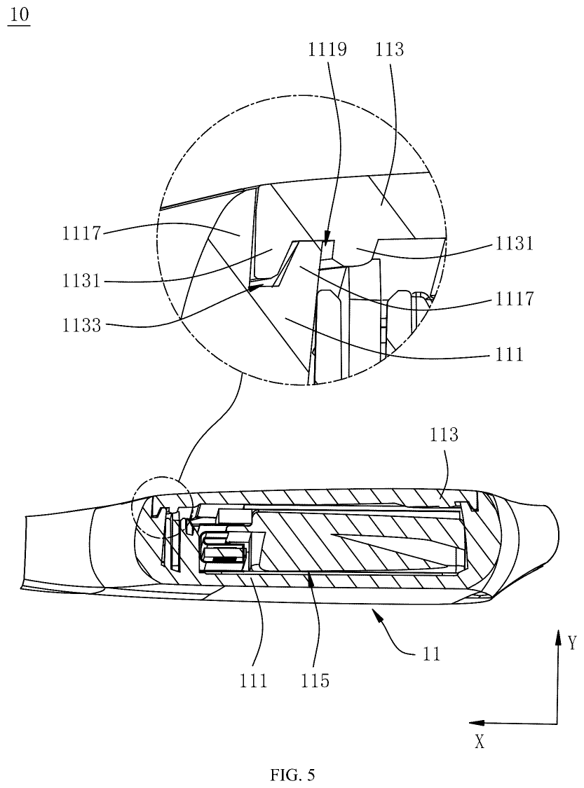

As illustrated in FIG. 3 and FIG. 5, in some embodiments, one of the box body 111 or the cover body 113 is provided with at least two first protuberances 1117 spaced apart from each other. Each of the at least two first protuberances 1117 is formed into an annular shape. A first adhesive groove 1119 is formed between two adjacent first protuberances 1117 of the at least two first protuberances 1117. The other one of the box body 111 or the cover body 113 is provided with a second protuberance 1131 engaged into the first adhesive groove 1119 in male-female fit.

Two, three, four, or more first protuberances 1117 may be provided, but the present disclosure is not limited thereto. When two first protuberances 1117 are provided, one first adhesive groove 1119 is formed. When three first protuberances 1117 are provided, two first adhesive grooves 1119 may be formed. When four first protuberances 1117 are provided, three first adhesive grooves 1119 may be formed. In the present disclosure, two first protuberances 1117 are provided. The first adhesive groove 1119 can be configured to hold the waterproof adhesive. The second protuberance 1131 may have the same annular structure as the first protuberance 1117.

As illustrated in FIG. 3 and FIG. 5, in an embodiment, the box body 111 is provided with at least two first protuberances 1117 on a side of the box body 111 facing towards the cover body 113, and the cover body 113 is provided with one second protuberance 1131 on a side of the cover body 113 facing towards the box body 111. The at least two first protuberances 1117 are arranged at intervals. When the box body 111 is connected to the cover body 113, the second protuberance 1131 extends into the first adhesive groove 1119 and is adhesively bonded to the first adhesive groove 1119 by the waterproof adhesive. Thus, the box body 111 can be fixedly connected to the cover body 113, and satisfactory waterproof performance is realized between the box body 111 and the cover body 113, in such a manner that the external liquid is unlikely to enter the mounting cavity 115 through the gap between the box body 111 and the cover body 113.

As illustrated in FIG. 3 and FIG. 5, in another embodiment, the box body 111 is provided with one second protuberance 1131 on the side of the box body 111 facing towards the cover body 113, and the cover body 113 is provided with at least two first protuberances 1117 on the side of the cover body 113 facing towards the box body 111. When the box body 111 is connected to the cover body 113, the second protuberance 1131 extends into the first adhesive groove 1119 and is adhesively bonded to the first adhesive groove 1119 by the waterproof adhesive. Thus, the box body 111 can be fixedly connected to the cover body 113, and satisfactory waterproof performance is realized between the box body 111 and the cover body 113, in such a manner that the external liquid is unlikely to enter the mounting cavity 115 through the gap between the box body 111 and the cover body 113.

In an embodiment of the present disclosure, the box body 111 is provided with the first protuberance 1117, and the cover body 113 is provided with the second protuberance 1131. In a case where the box body 111 is provided with at least two first protuberances 1117 and the cover body 113 is provided with the second protuberance 1131, the functional box 11 has a simple structure and is easy to manufacture.

As illustrated in FIG. 3 and FIG. 5, in some other embodiments, one of the box body 111 or the cover body 113 is provided with at least two third protuberances spaced apart from each other. Each of the at least two third protuberances is formed into an annular shape. A second adhesive groove is formed between two adjacent third protuberances of the at least two third protuberances. The other one of the box body 111 or the cover body 113 is provided with at least two fourth protuberances spaced apart from each other. Each of the at least two fourth protuberances is formed into an annular shape. A third adhesive groove 1133 is formed between two adjacent fourth protuberances of the at least two fourth protuberances. One of the at least two third protuberances is capable of being engaged into the third adhesive groove 1133 in male-female fit, and one of the at least two fourth protuberances is capable of being engaged into the second adhesive groove are in male-female fit.

The third protuberance may be the same as or different from the first protuberance 1117. The second adhesive groove may be the same as or different from the first adhesive groove 1119. The fourth protuberance may be the same as or different from the second protuberance 1131. In the present disclosure, as an example, the third protuberance is the same as the first protuberance 1117, the second adhesive groove is the same as the first adhesive groove 1119, and the fourth protuberance is the same as the second protuberance 1131. Both the second adhesive groove and the third adhesive groove 1133 can be configured to hold the waterproof adhesive.

Two, three, four, or more third protuberances may be provided, but the present disclosure is not limited thereto. When two third protuberances are provided, one second adhesive groove is formed. When three third protuberances are provided, two second adhesive grooves may be formed. When four third protuberances are provided, three second adhesive grooves may be formed. Two, three, four, or more fourth protuberances may be provided, but the present disclosure is not limited thereto. When two fourth protuberances are provided, one third adhesive groove 1133 is formed. When three fourth protuberances are provided, two third adhesive grooves 1133 may be formed. When four fourth protuberances are provided, three third adhesive grooves 1133 may be formed. In the present disclosure, two third protuberances are provided, and one second adhesive groove is formed. Two fourth protuberances are provided, and one third adhesive groove 1133 is formed.

As illustrated in FIG. 3 and FIG. 5, in an embodiment, the box body 111 is provided with two third protuberances on the side of the box body 111 facing towards the cover body 113, and the cover body 113 is provided with two fourth protuberances on the side of the cover body 113 facing towards the box body 111. The two third protuberances are spaced apart from each other. The two fourth protuberances are spaced apart from each other. In an example, the third protuberance proximal to a center of the mounting cavity 115 extends into the third adhesive groove 1133, while the fourth protuberance distal from the center of the mounting cavity 115 extends into the second adhesive groove. Both the second adhesive groove and the third adhesive groove 1133 contain the waterproof adhesive. In this way, the cover body 113 can be stably connected to the box body 111, and the functional box 11 has satisfactory waterproof performance. In another example, the third protuberance distal from the center of the mounting cavity 115 extends into the third adhesive groove 1133, and the fourth protuberance proximal to the center of the mounting cavity 115 extends into the second adhesive groove. Both the second adhesive groove and the third adhesive groove 1133 contain the waterproof adhesive. In this way, the cover body 113 can be stably connected to the box body 111, and the functional box 11 has satisfactory waterproof performance.

As illustrated in FIG. 3 and FIG. 5, in another embodiment, the box body 111 is provided with two fourth protuberances on the side of the box body 111 facing towards the cover body 113, and the cover body 113 is provided with two third protuberances on the side of the cover body 113 facing towards the box body 111. The two fourth protuberances are spaced apart from each other. The two third protuberances are spaced apart from each other. In an example, the fourth protuberance proximal to the center of the mounting cavity 115 extends into the second adhesive groove, and the third protuberance distal from the center of the mounting cavity 115 extends into the third adhesive groove 1133. Both the second adhesive groove and the third adhesive groove 1133 contain the waterproof adhesive. In this way, the cover body 113 can be stably connected to the box body 111, and the functional box 11 has satisfactory waterproof performance. In another example, the fourth protuberance distal from the center of the mounting cavity 115 extends into the second adhesive groove, and the third protuberance proximal to the center of the mounting cavity 115 extends into the third adhesive groove 1133. Both the second adhesive groove and the third adhesive groove 1133 contain the waterproof adhesive. In this way, the cover body 113 can be stably connected to the box body 111, and the functional box 11 has satisfactory waterproof performance.

In an embodiment of the present disclosure, the box body 111 is provided with two third protuberances on the side of the box body 111 facing towards the cover body 113, and the cover body 113 is provided with two fourth protuberances on the side of the cover body 113 facing towards the box body 111. The two third protuberances are spaced apart from each other. The two fourth protuberances are spaced apart from each other. The third protuberance proximal to the center of the mounting cavity 115 extends into the third adhesive groove 1133. The fourth protuberance distal from the center of the mounting cavity 115 extends into the second adhesive groove. In this case, the box body 111 is more stably connected to the cover body 113, and the functional box 11 has more satisfactory waterproof performance, which can further prevent the external liquid from entering the mounting cavity 115 through the gap between the box body 111 and the cover body 113.

As illustrated in FIG. 3 and FIG. 5, in some embodiments, in the thickness direction Y of the functional box 11, a height of the third protuberance proximal to the mounting cavity 115 is lower than a height of the third protuberance distal from the mounting cavity 115. In this case, when the box body 111 is connected to the cover body 113, the fourth protuberance extending into the second adhesive groove compresses the waterproof adhesive inside the second adhesive groove, and thus the waterproof adhesive is likely to overflow the second adhesive groove. In a case where the height of the third protuberance proximal to the mounting cavity 115 is lower than the height of the third protuberance distal from the mounting cavity 115, the waterproof adhesive may flow towards the mounting cavity 115 through the third protuberance proximal to the mounting cavity 115, effectively preventing the waterproof adhesive from overflowing to the outside of the functional box 11 and affecting an overall appearance of the functional box 11. It should be understood that, due to high viscosity of the waterproof adhesive, the waterproof adhesive may solidify on a sidewall of the mounting cavity 115 when flowing towards the mounting cavity 115 through the third protuberance, which can prevent the waterproof adhesive from flowing onto other components inside the mounting cavity 115 and affecting operation of the other components inside the mounting cavity 115. Additionally, in the case where the height of the third protuberance proximal to the mounting cavity 115 is lower than the height of the third protuberance distal from the mounting cavity 115, the third protuberance can be made of less material, saving material costs.

As illustrated in FIG. 3 and FIG. 5, in some other embodiments, in the thickness direction Y of the functional box 11, a height of the fourth protuberance proximal to the mounting cavity 115 is lower than a height of the fourth protuberance distal from the mounting cavity 115. In this case, when the box body 111 is connected to the cover body 113, the fourth protuberance extending into the third adhesive groove 1133 compresses the waterproof adhesive inside the third adhesive groove 1133, and thus the waterproof adhesive is likely to overflow the third adhesive groove 1133. In a case where the height of the fourth protuberance proximal to the mounting cavity 115 is lower than the height of the fourth protuberance distal from the mounting cavity 115, the waterproof adhesive may flow towards the mounting cavity 115 through the fourth protuberance proximal to the mounting cavity 115, effectively preventing the waterproof adhesive from overflowing to the outside of the functional box 11 and affecting the overall appearance of the functional box 11. It should be understood that, due to the high viscosity of the waterproof adhesive, the waterproof adhesive may solidify on the sidewall of the mounting cavity 115 when flowing towards the mounting cavity 115 through the fourth protuberance, which can prevent the waterproof adhesive from flowing onto other components inside the mounting cavity 115 and affecting the operation of the other components inside the mounting cavity 115. Additionally, in the case where the height of the fourth protuberance proximal to the mounting cavity 115 is lower than the height of the fourth protuberance distal from the mounting cavity 115, the fourth protuberance can be made of less material, saving the material costs.

As illustrated in FIG. 3 and FIG. 5, in yet some other embodiments, in the thickness direction Y of the functional box 11, the height of the third protuberance proximal to the mounting cavity 115 is lower than the height of the third protuberance distal from the mounting cavity 115, and the height of the fourth protuberance proximal to the mounting cavity 115 is lower than the height of the fourth protuberance distal from the mounting cavity 115. In this case, the waterproof adhesive can be further prevented from overflowing to the outside of the functional box 11. In this way, the waterproof adhesive does not affect the overall appearance of the functional box 11, leading to satisfactory aesthetics of the functional box 11. Moreover, both the third protuberance and the fourth protuberance can be made of less material, saving the material costs.

As illustrated in FIG. 3 and FIG. 4, in some embodiments, the connection component 13 includes a sleeve 133 and a mounting portion 135. The sleeve 133 includes a sleeve body 1331 and a protrusion 1333 disposed at an end of the sleeve body 1331. An outer side of the protrusion 1333 is formed as a sealing member 1335 of an annular shape. The protrusion 1333 extends into the insertion hole 1113. The sealing member 1335 abuts against an inner wall of the insertion hole 1113. The mounting portion 135 passes through the insertion hole 1113. An end of the mounting portion 135 disposed in the mounting cavity 115 is connected to the functional box 11 by the anti-detachment member 15. An end of the mounting portion 135 disposed outside the mounting cavity 115 extends into the protrusion 1333 to be connected to the sleeve body 1331. The protrusion 1333 is sleeved on an outer sidewall of the mounting portion 135.

The protuberance 132 is formed by the sleeve body 1331 and the mounting portion 135 together. The mounting portion 135 has greater hardness than the sleeve 133. In some embodiments, the sleeve 133 may be made of polymer, while the mounting portion 135 may be made of polymer. In a case where the mounting portion 135 is made of the polymer, the connection component 13 is stably connected to the functional box 11 when the mounting portion 135 is connected to the functional box 11. When the sleeve 133 is made of the polymer, an adjustment of a position or a shape of the connection component 13 by the user can be facilitated since the polymer can be easily deformed, in such a manner that the connection component 13 is more closely attached to the head of the user. In this way, the sleeve 133 and the mounting portion 135 may be connected in a manner of being integrally formed through two-color injection molding. Thus, the sleeve 133 is tightly connected to the mounting portion 135, in such a manner that the sleeve 133 and the mounting portion 135 are unlikely to be separated from each other.

The sealing member 1335 protrudes from a sidewall of the protrusion 1333. In a case where the mounting portion 135 passes through the insertion hole 1113, the mounting portion 135 may drive the protrusion 1333 to extend into the insertion hole 1113. When the connection component 13 is properly connected to the functional box 11, the sealing member 1335 may abut against the inner wall of the insertion hole 1113 (an inner sidewall of the connection portion 1111). Since the sealing member 1335 is made of the polymer, the sealing member 1335 is compressed and undergoes a predetermined deformation when the sealing member 1335 abuts against the inner wall of the insertion hole 1113. Thus, there is almost no gap between the sealing member 1335 and the inner wall of the insertion hole 1113, which makes it difficult for the external liquid to enter the mounting cavity 115 through a gap between the connection component 13 and the insertion hole 1113, providing satisfactory waterproof performance for the connection structure 10.

As illustrated in FIG. 3, in some embodiments, a plurality of sealing members 1335 are provided. The plurality of sealing members 1335 are arranged sequentially at intervals in an extension direction of the protrusion 1333. As an example, two, three, four, or more sealing members 1335 may be provided. In a case where a plurality of sealing members 1335 are provided, each of the plurality of sealing members 1335 abuts against the inner wall of the insertion hole 1113. In this way, a tight connection is achieved between the connection component 13 and the inner wall of the insertion hole 1113. As a result, the waterproof performance of the connection structure 10 can be further improved, and thus the external liquid is unlikely to enter the mounting cavity 115.

As illustrated in FIG. 3, in some embodiments, the sealing member 1335 has a closed annular structure. In this case, the sealing member 1335 has a simple structure and is easy to manufacture. In addition, the sealing member 1335 may abut against an entire circumference of the inner wall of the insertion hole 1113, leading to satisfactory waterproof performance of the connection structure 10. In other embodiments, the sealing member 1335 has an intermittent annular structure. In this case, the sealing member 1335 is made of less material, which can save the material.

As illustrated in FIG. 6, the headphone system 1000 according to an embodiment of the present disclosure includes the headphone 100 according to any of the above embodiments and a charging box 300 configured to charge the headphone 100. The charging box 300 has a charging compartment. When the headphone 100 needs charging, the battery box 117 of the headphone 100 may be accommodated within the charging compartment, allowing the charging box 300 to charge the battery inside the battery box 117.

In the headphone system 1000 according to the embodiment of the present disclosure, the connection component 13 extends into the insertion hole 1113 to be connected to the functional box 11. The anti-detachment member 15 is located in the mounting cavity 115, and is configured to further stably connect the functional box 11 with the connection component 13, effectively preventing the connection component 13 from detaching from the functional box 11. Compared with the conventional connection structure 10, the connection structure 10 of the present disclosure realizes that the anti-detachment member 15 enables the functional box 11 to be stably connected to the connection component 13 without extending through the functional box 11. As a result, the external liquid is unlikely to enter the mounting cavity 115 through the gap between the anti-detachment member 15 and the functional box 11, which enables the satisfactory waterproof performance of the connection structure 10, effectively avoiding the problem that the external liquid enters the mounting cavity 115 and affects the normal operation of the mainboard compartment inside the functional box 11.

Technical features in the above embodiments can be combined arbitrarily. For concise description, not all possible combinations of the technical features in the above embodiments are described. However, any combination of the technical features in the above embodiments should be considered as falling within the scope of the present disclosure, as long as no conflict occurs between combinations of the technical features. Also, other embodiments can be derived from the above embodiments, such that structural and logical substitutions and changes can be made without departing from the scope of the present disclosure.

While several embodiments of the present disclosure have been described above in a specific and detailed manner, the protection scope of the present disclosure cannot be construed as being limited to these embodiments. It should be noted that, those skilled in the art can make various variants and improvements without departing from the concept of the present disclosure, and these variants and improvements shall fall within the protection scope of present disclosure as defined by the claims as attached.

What is claimed is:

1. A connection structure, comprising:
a functional box comprising a box body and a cover body mounted at the box body, the cover body being engaged with the box body to define a mounting cavity, wherein the box body is provided with a connection portion on at least one end of the box body, wherein the connection portion has an insertion hole extending through the connection portion, and wherein the insertion hole is configured to communicate the mounting cavity with an external environment;
a connection component connected to the functional box, wherein the insertion hole is configured to allow the connection component to be inserted into the insertion hole, and wherein the connection component is provided with a protuberance abutting against a sidewall of the functional box; and
an anti-detachment member located in the mounting cavity, wherein the anti-detachment member is configured to fixedly connect the functional box with the connection component.

2. The connection structure according to claim 1, wherein:
the connection portion further has a connection hole located in the mounting cavity and in communication with the insertion hole; and
the connection component has a mating hole corresponding to the connection hole,
wherein the anti-detachment member passes through the connection hole and the mating hole to connect the functional box with the connection component.

3. The connection structure according to claim 2, wherein an extension direction of the connection hole is different from an extension direction of the insertion hole.

4. The connection structure according to claim 3, wherein the extension direction of the connection hole is perpendicular to the extension direction of the insertion hole.

5. The connection structure according to claim 3, wherein:
the insertion hole extends through two opposite sidewalls of the connection portion; and
the connection hole extends through a top wall of the connection portion, two ends of the top wall being connected to the two opposite sidewalls of the connection portion.

6. The connection structure according to claim 1, wherein:
at least part of the connection component extends into the mounting cavity; and
the anti-detachment member is disposed at an end of the connection component, the end of the connection component being located in the mounting cavity, the anti-detachment member being engaged with a sidewall of the connection portion to connect the functional box with the connection component.

7. The connection structure according to claim 6, wherein the anti-detachment member is a snap hook snapped with the sidewall of the connection portion.

8. The connection structure according to claim 6, wherein:
the connection component comprises an expansion bolt inserted into the insertion hole and engaged with a sidewall of the insertion hole;
the anti-detachment member is disposed at an end of the expansion bolt, the end of the expansion bolt being located in the mounting cavity; and
the anti-detachment member is a snap hook snapped with the sidewall of the connection portion.

9. The connection structure according to claim 1, wherein the cover body and the box body are connected to each other through adhesive bonding.

10. The connection structure according to claim 9, wherein:
one of the box body or the cover body is provided with at least two first protuberances spaced apart from each other, each of the at least two first protuberances being formed into an annular shape, and a first adhesive groove being formed between two adjacent first protuberances of the at least two first protuberances; and
the other one of the box body or the cover body is provided with a second protuberance engaged into the first adhesive groove, the second protuberance being engaged into the first adhesive groove in male-female fit.

11. The connection structure according to claim 9, wherein:
one of the box body or the cover body is provided with at least two third protuberances spaced apart from each other, each of the at least two third protuberances being formed into an annular shape, and a second adhesive groove being formed between two adjacent third protuberances of the at least two third protuberances; and
the other one of the box body or the cover body is provided with at least two fourth protuberances spaced apart from each other, each of the at least two fourth protuberances being formed into an annular shape, and a third adhesive groove being formed between two adjacent fourth protuberances of the at least two fourth protuberances, wherein:
one of the at least two third protuberances is capable of being engaged into the third adhesive groove in male-female fit; and
one of the at least two fourth protuberances is capable of being engaged into the second adhesive groove in male-female fit.

12. The connection structure according to claim 11, wherein:
in a thickness direction of the functional box, a height of one of the at least two third protuberances proximal to the mounting cavity is lower than a height of one of the at least two third protuberances distal from the mounting cavity; and/or
in the thickness direction of the functional box, a height of one of the at least two fourth protuberances proximal to the mounting cavity is lower than a height of one of the at least two fourth protuberances distal from the mounting cavity.

13. The connection structure according to claim 1, wherein the functional box further comprises a battery box for receiving a battery and/or a control box with a control function.

14. The connection structure according to claim 1, wherein the connection component comprises an ear hook of a headphone and/or a rear hook of a headphone.

15. The connection structure according to claim 1, wherein the connection component comprises:
a sleeve comprising a sleeve body and a protrusion disposed at an end of the sleeve body, wherein an outer side of the protrusion is formed as a sealing member of an annular shape, wherein the protrusion extends into the insertion hole, the sealing member abutting against an inner wall of the insertion hole; and
a mounting portion passing through the insertion hole, wherein an end of the mounting portion located in the mounting cavity is connected to the functional box by the anti-detachment member, and wherein an end of the mounting portion disposed outside the mounting cavity extends into the protrusion to be connected to the sleeve body, the protrusion being sleeved on an outer sidewall of the mounting portion.

16. The connection structure according to claim 15, wherein a plurality of sealing members are provided, the plurality of sealing members being arranged sequentially at intervals in an extension direction of the protrusion.

17. The connection structure according to claim 15, wherein:
the sealing member has a closed annular structure; or
the sealing member has an intermittent annular structure.

18. A headphone, comprising a connection structure, wherein the connection structure comprises:
a functional box comprising a box body and a cover body mounted at the box body, the cover body being engaged with the box body to define a mounting cavity, wherein the box body is provided with a connection portion on at least one end of the box body, wherein the connection portion has an insertion hole extending through the connection portion, and wherein the insertion hole is configured to communicate the mounting cavity with an external environment;
a connection component connected to the functional box, wherein the insertion hole is configured to allow the connection component to be inserted into the insertion hole, and wherein the connection component is provided with a protuberance abutting against a sidewall of the functional box; and
an anti-detachment member disposed in the mounting cavity, wherein the anti-detachment member is configured to fixedly connect the functional box with the connection component.

19. The headphone according to claim 18, wherein the headphone comprises a bone conduction headphone or an air conduction headphone.

20. A headphone system, comprising:
a headphone comprising a connection structure, wherein the connection structure comprises:
a functional box comprising a box body and a cover body mounted at the box body, the cover body being engaged with the box body to define a mounting cavity, wherein the box body is provided with a connection portion on at least one end of the box body, wherein the connection portion has an insertion hole extending through the connection portion, and wherein the insertion hole is configured to communicate the mounting cavity with an external environment;
a connection component connected to the functional box, wherein the insertion hole is configured to allow the connection component to be inserted into the insertion hole, and wherein the connection component is provided with a protuberance abutting against a sidewall of the functional box; and
an anti-detachment member disposed in the mounting cavity, wherein the anti-detachment member is configured to fixedly connect the functional box with the connection component; and
a charging box configured to charge the headphone.
